(19) United States
(12) Patent Application Publication
(10) Pub. No.: US 2010/0037180 A1
(43) Pub. Date: Feb. 11, 2010

(54) Touch Screen Remote Control with Dynamic Keypad Layouts

(75) Inventors: Mark A. Elias, Eastpointe, MI (US); Sherry Soja-Molloy, Taylor, MI (US); Neil A. Jacobson, San Antonio, TX (US)

Correspondence Address: AT&T Legal Department - LNA;Attn: Patent Docketing, Room 2A- 207, One AT & T Way, Bedminster, NJ, 07921, US

(73) Assignee: AT&T INTELLECTUAL PROPERTY I, L.P., Reno, NV (US)

(21) Appl. No.: 12/188,315

(22) Filed: Aug. 8, 2008

(51) Int. Cl. G06F 3/048

(52) U.S. Cl. 715/840

(57) ABSTRACT

A remote control device comprising a touch screen, a mode module, and a programming module. The touch screen is configured to display a plurality of buttons for interaction with a television. The mode module is configured to receive a mode request and to populate the touch screen with one of a plurality of button layouts based on the mode request. The programming module is in communication with the touch screen and with the mode module, and is adapted to receive a user defined button layout and to store the user defined button layout in the mode module.

### FIELD OF THE DISCLOSURE

The present disclosure generally relates to communications networks, and more particularly relates to a remote control device for a set-top box.

### BACKGROUND

Remote controls are common for set-top box devices, televisions, digital video disc (DVD) players, and the like. Some remote controls, known as universal remote controls, can be programmed to function with multiple target devices. In most cases, remote controls typically send an infrared (IR) control signal via an IR transmitter. The target device uses the IR control signal to determine what command function the user is requesting.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating an Internet Protocol Television (IPTV) network;

FIG. 2 is a plan view of a remote control device;

FIG. 3 is a block diagram of a plurality of components within the remote control device;

FIG. 4 is a plan view of a button layout of the remote control device;

FIG. 5 is a plan view of an alternate button layout of the remote control device;

FIG. 6 is a flow diagram of a method for customizing the button layout on the remote control device;

FIG. 7 is a flow diagram of a method for controlling multiple devices with the remote control device; and

FIG. 8 is a block diagram of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed inventions. Moreover, some statements may apply to some inventive features but not to others.

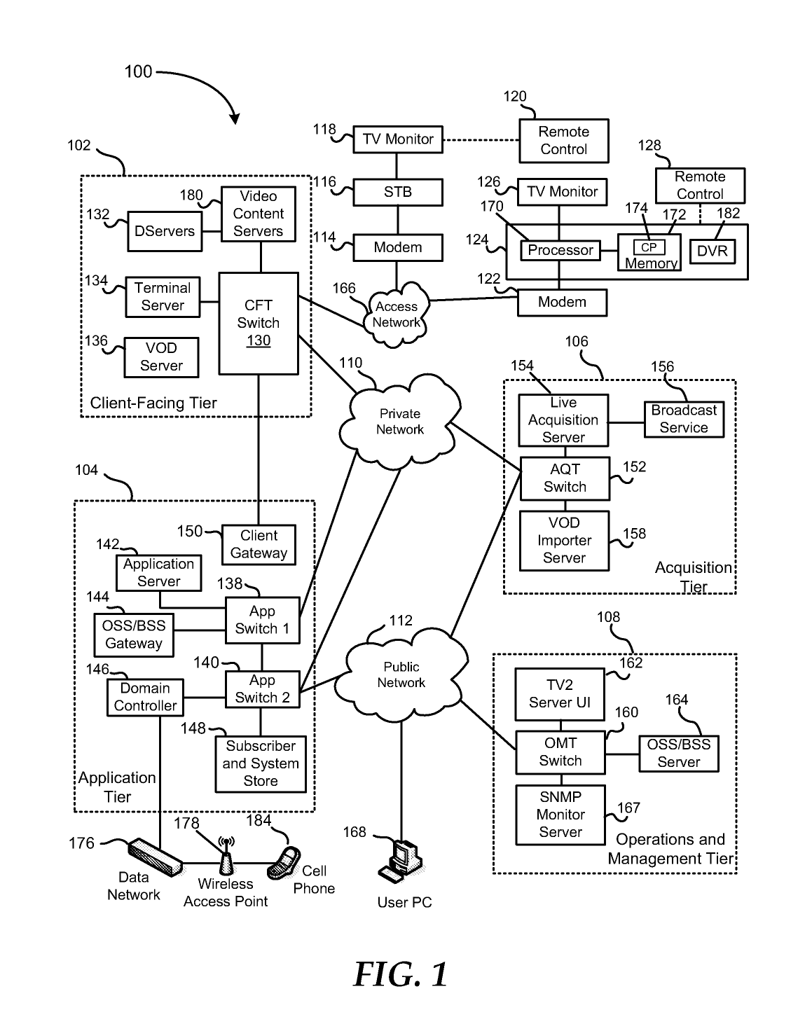

FIG. 1 shows an IPTV system 100 including a client facing tier 102, an application tier 104, an acquisition tier 106, and an operations and management tier 108. Each tier 102, 104, 106, and 108 is coupled to one or both of a private network 110 and a public network 112. For example, the client-facing tier 102 can be coupled to the private network 110, while the application tier 104 can be coupled to the private network 110 and to the public network 112 such as the Internet. The acquisition tier 106 can also be coupled to the private network 110 and to the public network 112. Moreover, the operations and management tier 108 can be coupled to the public network 112.

The various tiers 102, 104, 106 and 108 communicate with each other via the private network 110 and the public network 112. For instance, the client-facing tier 102 can communicate with the application tier 104 and the acquisition tier 106 via the private network 110. The application tier 104 can also communicate with the acquisition tier 106 via the private network 110. Further, the application tier 104 can communicate with the acquisition tier 106 and the operations and management tier 108 via the public network 112. Moreover, the acquisition tier 106 can communicate with the operations and management tier 108 via the public network 112. In a particular embodiment, elements of the application tier 104 can communicate directly with the client-facing tier 102.

The client-facing tier 102 can communicate with user equipment via a private access network 166, such as an Internet Protocol Television (IPTV) network. In an illustrative embodiment, modems such as a first modem 114 and a second modem 122 can be coupled to the private access network 166. The client-facing tier 102 can communicate with a first representative set-top box device 116 via the first modem 114 and with a second representative set-top box device 124 via the second modem 122. The client-facing tier 102 can communicate with a large number of set-top boxes over a wide geographic area, such as a regional area, a metropolitan area, a viewing area, or any other suitable geographic area that can be supported by networking the client-facing tier 102 to numerous set-top box devices. In one embodiment, the client-facing tier 102 can be coupled to the modems 114 and 122 via fiber optic cables. Alternatively, the modems 114 and 122 can be digital subscriber line (DSL) modems that are coupled to one or more network nodes via twisted pairs, and the client-facing tier 102 can be coupled to the network nodes via fiber-optic cables. Each set-top box device 116 and 124 can process data received from the private access network 166 via an IPTV software platform such as Microsoft® TV IPTV Edition.

The first set-top box device 116 can be coupled to a first display device 118, such as a first television monitor, and the second set-top box device 124 can be coupled to a second display device 126, such as a second television monitor. Moreover, the first set-top box device 116 can communicate with a first remote control 120, and the second set-top box device can communicate with a second remote control 128. In an exemplary, non-limiting embodiment, each set-top box device 116 and 124 can receive data or video from the client-facing tier 102 via the private access network 166 and render or display the data or video at the display device 118 or 126 to which it is coupled. The set-top box devices 116 and 124 thus may include tuners that receive and decode television programming information for transmission to the display devices 118 and 126. Further, the set-top box devices 116 and 124 can include a set-top box processor 170 and a set-top box memory device 172 that is accessible to the set-top box processor. In a particular embodiment, the set-top box devices 116 and 124 can also communicate commands received from the remote controls 120 and 128 back to the client-facing tier 102 via the private access network 166.

In an illustrative embodiment, the client-facing tier 102 can include a client-facing tier (CFT) switch 130 that manages communication between the client-facing tier 102 and the private access network 166 and between the client-facing tier 102 and the private network 110. As shown, the CFT switch 130 is coupled to one or more data servers 132 that store data transmitted in response to user requests, such as video-on-demand material. The CFT switch 130 can also be coupled to a terminal server 134 that provides terminal devices, such as a game application server and other devices with a common connection point to the private network 110. In a particular embodiment, the CFT switch 130 can also be coupled to a video-on-demand (VOD) server 136.

The application tier 104 can communicate with both the private network 110 and the public network 112. In this embodiment, the application tier 104 can include a first application tier (APP) switch 138 and a second APP switch 140. In a particular embodiment, the first APP switch 138 can be coupled to the second APP switch 140. The first APP switch 138 can be coupled to an application server 142 and to an OSS/BSS gateway 144. The application server 142 provides applications to the set-top box devices 116 and 124 via the private access network 166, so the set-top box devices 116 and 124 can provide functions such as display, messaging, processing of IPTV data and VOD material. In a particular embodiment, the OSS/BSS gateway 144 includes operation systems and support (OSS) data, as well as billing systems and support (BSS) data.

The second APP switch 140 can be coupled to a domain controller 146 that provides web access, for example, to users via the public network 112. The second APP switch 140 can be coupled to a subscriber and system store 148 that includes account information, such as account information that is associated with users who access the system 100 via the private network 110 or the public network 112. In a particular embodiment, the application tier 104 can also include a client gateway 150 that communicates data directly to the client-facing tier 102. In this embodiment, the client gateway 150 can be coupled directly to the CFT switch 130. The client gateway 150 can provide user access to the private network 110 and the tiers coupled thereto.

In a particular embodiment, the set-top box devices 116 and 124 can access the system via the private access network 166 using information received from the client gateway 150. The private access network 166 provides security for the private network 110. User devices can access the client gateway 150 via the private access network 166, and the client gateway 150 can allow such devices to access the private network 110 once the devices are authenticated or verified. Similarly, the client gateway 150 can prevent unauthorized devices, such as hacker computers or stolen set-top box devices, from accessing the private network 110 by denying access to these devices beyond the private access network 166.

For example, when the set-top box device 116 accesses the system 100 via the private access network 166, the client gateway 150 can verify subscriber information by communicating with the subscriber and system store 148 via the private network 110, the first APP switch 138 and the second APP switch 140. Further, the client gateway 150 can verify billing information and status by communicating with the OSS/BSS gateway 144 via the private network 110 and the first APP switch 138. The OSS/BSS gateway 144 can transmit a query across the first APP switch 138, to the second APP switch 140, and the second APP switch 140 can communicate the query across the public network 112 to the OSS/BSS server 164. After the client gateway 150 confirms subscriber and/or billing information, the client gateway 150 can allow the set-top box device 116 access to IPTV content and VOD content. If the client gateway 150 cannot verify subscriber information for the set-top box device 116, such as because it is connected to a different twisted pair, the client gateway 150 can deny transmissions to and from the set-top box device 116 beyond the private access network 166.

The acquisition tier 106 includes an acquisition tier (AQT) switch 152 that communicates with the private network 110. The AQT switch 152 can also communicate with the operations and management tier 108 via the public network 112. In a particular embodiment, the AQT switch 152 can be coupled to a live acquisition server 154 that receives television content, for example, from a broadcast service 156. Further, the AQT switch can be coupled to a video-on-demand importer server 158 that stores television content received at the acquisition tier 106 and communicate the stored content to the client-facing tier 102 via the private network 110.

The operations and management tier 108 can include an operations and management tier (OMT) switch 160 that conducts communication between the operations and management tier 108 and the public network 112. In the illustrated embodiment, the OMT switch 160 is coupled to a TV2 server 162. Additionally, the OMT switch 160 can be coupled to an OSS/BSS server 164 and to a simple network management protocol (SNMP) monitor 167 that monitors network devices. In a particular embodiment, the OMT switch 160 can communicate with the AQT switch 152 via the public network 112.

In a particular embodiment during operation of the IPTV system, the live acquisition server 154 can acquire television content from the broadcast service 156. The live acquisition server 154 in turn can transmit the television content to the AQT switch 152 and the AQT switch can transmit the television content to the CFT switch 130 via the private network 110. Further, the television content can be encoded at the D-servers 132, and the CFT switch 130 can communicate the television content to the modems 114 and 122 via the private access network 166. The set-top box devices 116 and 124 can receive the television content from the modems 114 and 122, decode the television content, and transmit the content to the display devices 118 and 126 according to commands from the remote control devices 120 and 128.

Additionally, at the acquisition tier 106, the VOD importer server 158 can receive content from one or more VOD sources outside the IPTV system 100, such as movie studios and programmers of non-live content. The VOD importer server 158 can transmit the VOD content to the AQT switch 152, and the AQT switch 152 in turn can communicate the material to the CFT switch 130 via the private network 110. The VOD content can be stored at one or more servers, such as the VOD server 136.

When a user issues a request for VOD content to the set-top box device 116 or 124, the request can be transmitted over the private access network 166 to the VOD server 136 via the CFT switch 130. Upon receiving such a request, the VOD server 136 can retrieve requested VOD content and transmit the content to the set-top box device 116 or 124 across the private access network 166 via the CFT switch 130. In an illustrative embodiment, the live acquisition server 154 can transmit the television content to the AQT switch 152, and the AQT switch 152 in turn can transmit the television content to the OMT switch 160 via the public network 112. In this embodiment, the OMT switch 160 can transmit the television content to the TV2 server 162 for display to users accessing the user interface at the TV2 server. For example, a user can access the TV2 server 162 using a personal computer (PC) 168 coupled to the public network 112.

The domain controller 146 communicates with the public network 112 via the second APP switch 140. Additionally, the domain controller 146 can communicate via the public network 112 with the PC 168. For example, the domain controller 146 can display a web portal via the public network 112 and allow users to access the web portal using the PC 168. Further, in an illustrative embodiment, the domain controller 146 can communicate with at least one wireless network access point 178 over a data network 176. In this embodiment, each wireless network access device 178 can communicate with user wireless devices such as a cellular telephone 184.

In a particular embodiment, the set-top box devices can include a set-top box computer program 174 that is embedded within the set-top box memory device 172. The set-top box computer program 174 can contain instructions to receive and execute at least one user television viewing preference that a user has entered by accessing an Internet user account via the domain controller 146. For example, the user can use the PC 168 to access a web portal maintained by the domain controller 146 via the Internet. The domain controller 146 can query the subscriber and system store 148 via the private network 110 for account information associated with the user. In a particular embodiment, the account information can associate the user's Internet account with the second set-top box device 124. For instance, in an illustrative embodiment, the account information can relate the user's account to the second set-top box device 124 by associating the user account with an IP address of the second set-top box device, with data relating to one or more twisted pairs connected with the second set-top box device, with data related to one or more fiber optic cables connected with the second set-top box device, with an alphanumeric identifier of the second set-top box device, with any other data that is suitable for associating the second set-top box device with a user account, or with any combination of these.

The set-top box computer program 174 can contain instructions to receive many types of user preferences from the domain controller 146 via the access network 166. For example, the set-top box computer program 174 can include instructions to receive a request to record at least one television program at a video content storage module such as a digital video recorder (DVR) 182 within the second set-top box device 124. In this example embodiment, the set-top box computer program 174 can include instructions to transmit the request to the DVR 182, where the television program(s) are recorded. In an illustrative embodiment, the set-top box computer program 174 can include instructions to receive from the DVR 182 a recording status with respect to one or more of the television programs and to transmit at least one message regarding the status to a wireless device, such as the cellular telephone 184. The message can be received at the CFT switch 130, for instance, and communicated to the domain controller 146 across the private network 110 via the second APP switch 140. Further, the domain controller 146 can transmit the message to the wireless data network 176, directly or via the public network 112, and on to the wireless network access point 178. The message can then be transmitted to the cellular telephone 184. In an illustrative embodiment, the status can be sent via a wireless access protocol (WAP).

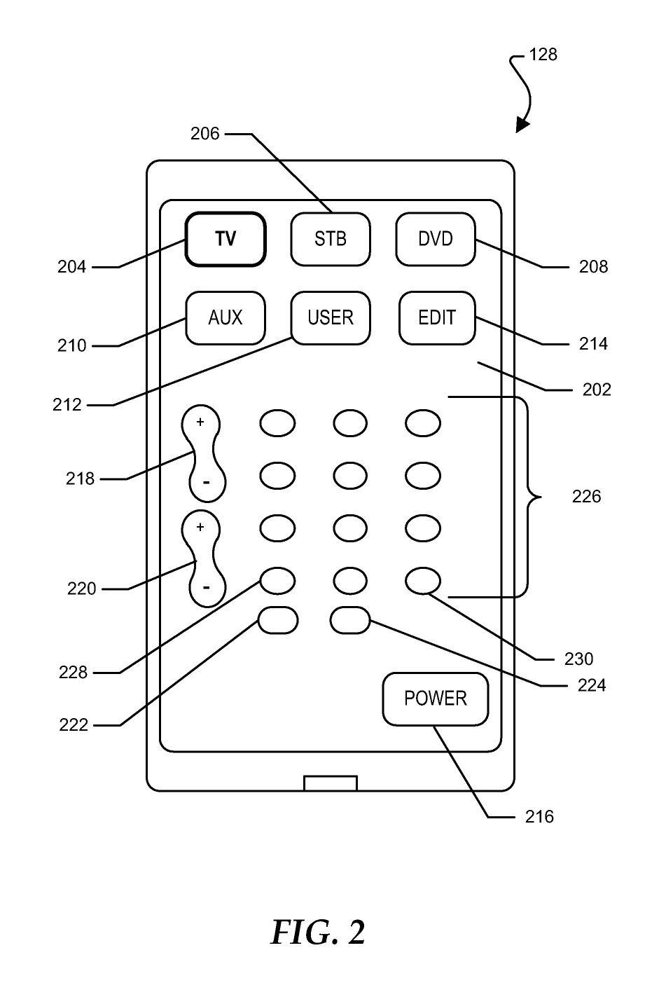

FIG. 2 shows the remote control device 128 including a touch screen 202 having a plurality of mode soft buttons such as a television (TV) button 204, a set-top box device button 206, a digital video disc (DVD) button 208, an auxiliary (AUX) button 210, a user button 212, an edit button 214, and a power button 216. When the TV button 204 is pressed, the remote control device 206 can be used to control the display device 126 connected to the set-top box device 124. When the set-top box device button 206 is pressed, the remote control device 128 can be used to control the set-top box device 124. When the DVD button 208 is pressed, the remote control device 128 can be used to control a DVD player connected to the display device 126 or to the set-top box device 124. Additionally, when the AUX button 210 is pressed, the remote control device 128 can be used to control an auxiliary device connected to the display device 126 or to the set-top box device 124. For example, the auxiliary device can be a compact disc (CD) player, a video cassette recorder (VCR), an audio receiver, or some other home entertainment device. When the user button 212 is pressed, the remote control device 128 can display a plurality of buttons associated with different members of a household. When the edit button 214 is pressed, the remote control device 128 can be used to create a customized button layout for a device or a user.

When one of the mode buttons is pressed, a button layout corresponding to the mode button is displayed on the touch screen 202 to allow the user to control the related device. For example, when the TV button 204 is pressed, the touch screen can be populated with a volume up/down button 218, a channel up/down button 220, a mute button 222, and a last button 224. The volume button 218 can be used to control the volume of the display device 126. The channel button 220 can be used to change the channel output at the display device 126. The last button 224 can be used to return to the last channel viewed by the user on the display device 126.

The remote control device 128 can also include a numerical keypad 226 having a plurality of buttons that are individually numbered 1, 2, 3, 4, 5, 6, 7, 8, 9, and 0. The numerical keypad 226 is configured similar to a telephone keypad and each individual button also includes a portion of the alphabet. The 2 button includes ABC, the 3 button includes DEF, the 4 button includes GHI, the 5 button includes JKL, the 6 button includes MNO, the 7 button includes PQRS, the 8 button includes TUV, and the 9 button includes WXYZ. The 0 button can also be used as a SPACE button. In a particular embodiment, the numerical keypad 226 can be used to input a specific channel number. The numerical keypad 226 can also include a delete button 228 and an enter button 230.

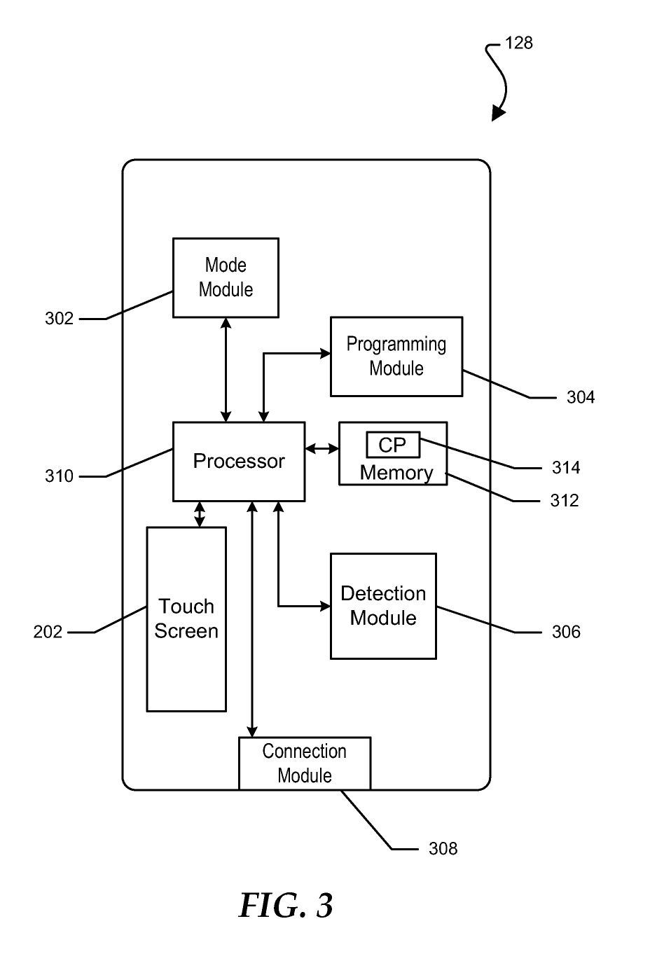

FIG. 3 shows a block diagram of a plurality of components within the remote control device 128 including a mode module 302, a programming module 304, a detection module 306, a connection module 308, a processor 310, and a memory 312 including a computer program 314 executable by the processor 310. The mode module 302 is in communication with the touch screen 202, with the connection module 308, and with the detection module 306 via the processor 310. The programming module 304 is in communication with the touch screen 202 and with the connection module 308 via the processor 310. The detection module 306 is in communication with the touch screen 202 via the processor 310. The processor 310 is in communication with the memory 312.

As a soft button displayed on the touch screen 202 is pressed, the processor 310 can perform different operations based on the computer program 314 stored in the memory 312. If a soft button pressed is associated with a mode button, such as the TV button 204, the set-top box device button 206, the DVD button 208, or the AUX button 210, then the mode module 302 can determine a layout mode requested and output the corresponding button layout to the touch screen 202. The soft buttons populated on the touch screen 202 can vary based on the device, such that only the buttons needed to control a given device are displayed on the touch screen.

If the user button 212 is selected, the mode module 302 can output different soft buttons corresponding to different customized button layouts for the different users of the remote control device 128. If the edit button 214 is selected, the touch screen 202 can be populated with a plurality of different soft buttons that the user can drag to different locations on the touch screen to create a customized button layout for a specific user and/or a specific device. For example, one user of the household may prefer to have the channel button 220 on the left side of the touch screen 202 while another user may prefer to have the channel button on the right side of the touch screen. The programming module 304 can determine the different locations of the soft buttons, and store the desired button layout in the memory 312 via the processor 310. The connection module 308 can provide communication between the remote control device 128 and an external device so that the remote control can receive different button layouts from the external device. The connection module 308 can communicate with the external device by way of a universal serial bus connection, a radio frequency connection, an ultra high frequency connection, and the like.

The detection module 306 can determine when the remote control device 128 is in communication with a device such as the set-top box device 124, the display device 126, the DVD player, and the like. The detection module 306 can scan an area surrounding the remote control device 128 for a radio frequency signal, an infrared signal, an ultra high frequency signal, and the like associated with the different devices to determine if the remote control device is in communication with one of the devices. Upon the detection module 306 determining that the remote control device 128 is in communication with one of the devices, the touch screen 202 can be populated with an initial button layout previously selected by the user. For example, upon the detection module 306 determining that the remote control device 128 is in communication with one of the devices, the TV button 204, the set-top box device button 206, the DVD button 208, the AUX button 210, the user button 212, and the edit button 214 can be displayed on the touch screen 202, allowing the user to select which device the user wants to control.

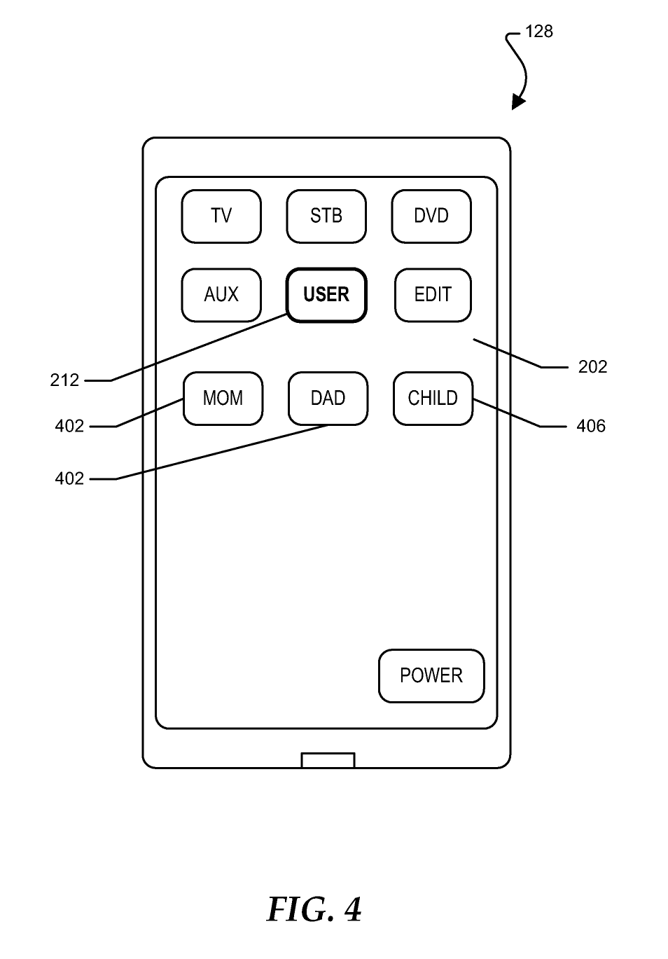

When the user button 214 is pressed, a user button layout can be displayed on the touch screen 202 including different buttons for the different users in a household, such as a mom button 402, a dad button 404, and a child button 406 as shown in FIG. 4. The user of the remote control device 128 can select either the mom button 402, the dad button 404, or the child button 406 to have the touch screen 202 populated with a customized button layout for the specific user.

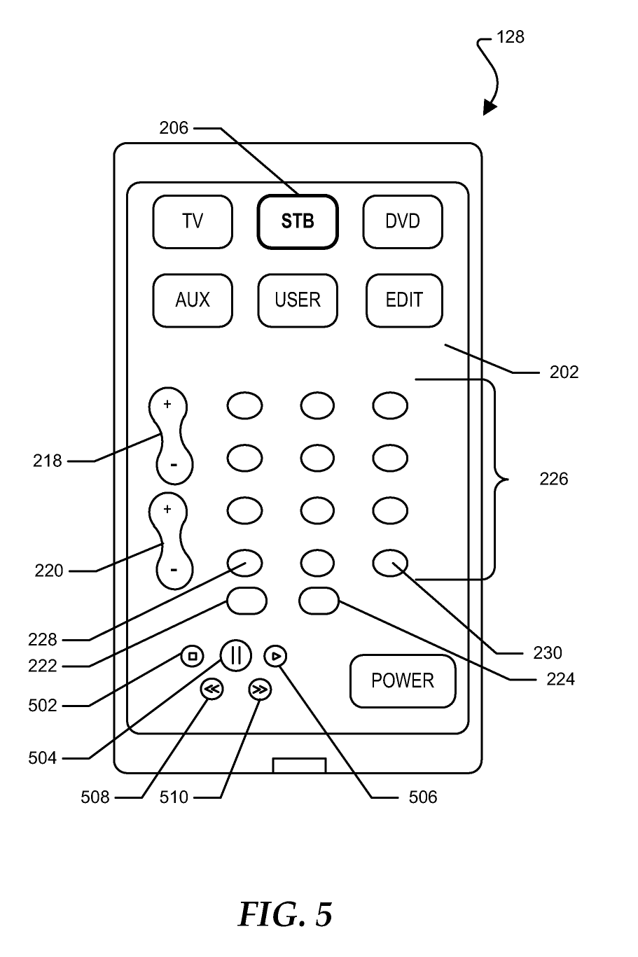

Upon the set-top box device button 206 being pressed, the touch screen 202 can be populated with a button layout to control the set-top box device 128. FIG. 5 shows the remote control device 128 in the set-top box device mode including a stop button 502, a pause button 504, a play button 506, a rewind button 508, and a fast forward button 510. These buttons can be used to control the content received at the set-top box device 124, such as a live television program broadcast, VOD content, movie-on-demand (MOD) content, recorded content, and the like. The volume button 218, the channel button 220, the last button 224, the numerical keypad 226, the delete button 228, and the enter button 230 can be used to navigate through different broadcast television channels provided from the IPTV system 100 to the set-top box device 124. The stop button 502 can be pressed to end the MOD content, the VOD content, the recorded content, and the like. Upon the pause button 504 being pressed, the display of a video stream associated with the MOD content, the VOD content, the recorded content, the live television program broadcast, and the like can be paused. The play button 506 can be used to initiate or restart the MOD content, the VOD content, or the recorded content. The rewind button 508 and the fast forward button 510 can be used to advance backward or forward in a video stream associated with the program being output to the display device 126.

In an embodiment, a telephone, a personal digital assistant, or any other device having the touch screen 202 can download the remote control computer program 314 to be stored in its the memory 312. The computer program 314 can populate specific buttons needed to control different devices, such as the set-top box device 124, the display device 126, and the like. Additionally, the computer program 314 can include instructions to scan for the different devices to be controlled, and instructions to switch the button layout on the touch screen 202 so that the any located device can be controlled.

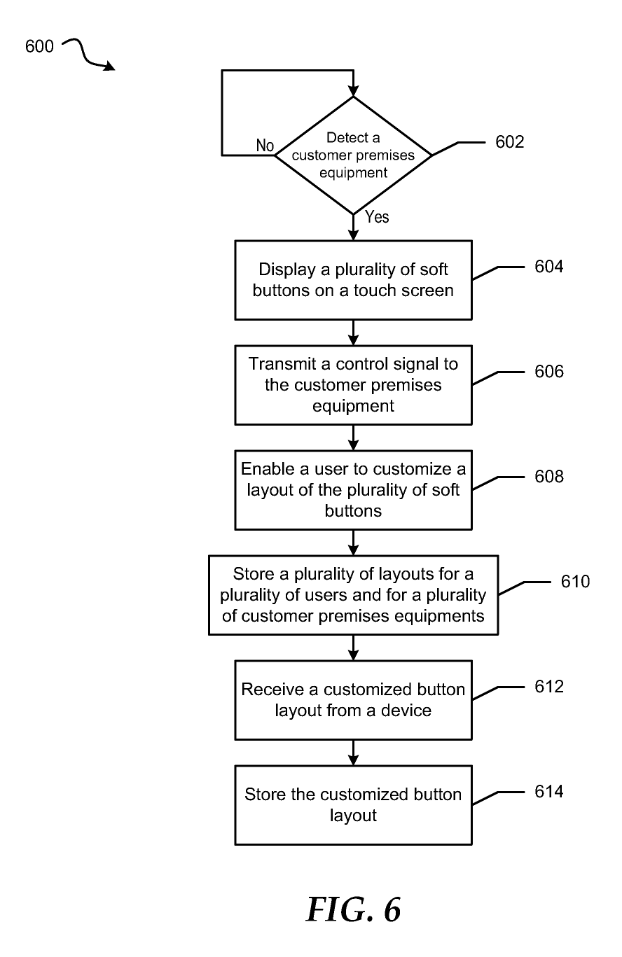

The programming module 304 can enable the user to customize different button layouts on the touch screen 202. FIG. 6 shows a flow diagram of a method 600 for customizing a button layout on the remote control device 128. At block 602, a determination is made whether any customer premises equipment is detected by the remote control device. The customer premises equipment can be a set-top box device, a television, a digital video recorder, a VCR, a DVD player, a CD player, and the like. A plurality of soft buttons is displayed on a touch screen at block 604. At block 606, a control signal is transmitted to the customer premises equipment based on one of the plurality of soft buttons being pressed. The user is enabled to customize a layout of the plurality of soft buttons at block 608. At block 610, a plurality of layouts is stored for a plurality of users and for a plurality of customer premises equipments. A customized button layout is received from a device at block 612. At block 614, the customized button layout is stored in the remote control device.

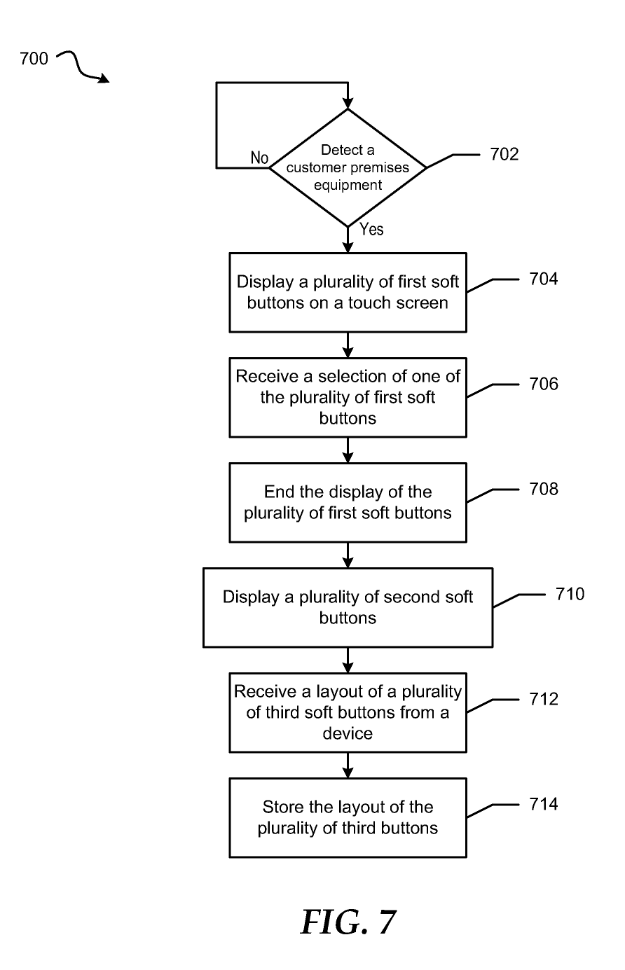

The remote control device 128 can display a plurality of button layouts, and each button layout can be used to control a different device in communication with the remote control. FIG. 7 shows a flow diagram of a method 700 for controlling multiple devices with the remote control device 128. At block 702, a determination is made whether any customer premises equipment is detected by the remote control device. A plurality of first soft buttons is displayed on a touch screen at block 704. At block 706, a selection of one of the plurality of first soft buttons is received. The display of the plurality of first soft buttons is ended at block 708. At block 710, a plurality of second soft buttons is displayed on the touch screen. A layout of a plurality of third soft buttons is received from a device at block 712. At block 714, the layout of the plurality of third soft buttons is stored.

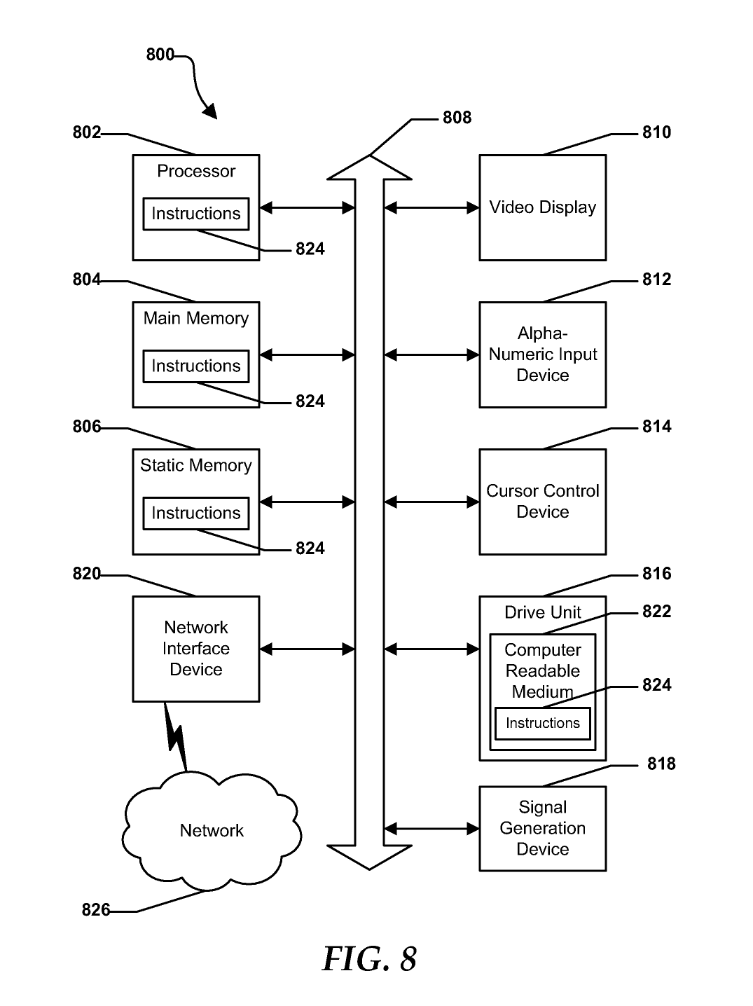

FIG. 8 shows an illustrative embodiment of a general computer system 800 in accordance with at least one embodiment of the present disclosure. The computer system 800 can include a set of instructions that can be executed to cause the computer system to perform any one or more of the methods or computer based functions disclosed herein. The computer system 800 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 800 can also be implemented as or incorporated into various devices, such as a personal computer (PC), a tablet PC, a set-top box, a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 800 can be implemented using electronic devices that provide voice, video or data communication. Further, while a single computer system 800 is illustrated, the term “system” shall also be taken to include any collection of systems or sub-systems that individually or jointly execute a set, or multiple sets, of instructions to perform one or more computer functions.

The computer system 800 may include a processor 802, e.g., a central processing unit (CPU), a graphics processing unit (GPU), or both. Moreover, the computer system 800 can include a main memory 804 and a static memory 806 that can communicate with each other via a bus 808. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. The computer system 800 can also include a disk drive unit 816, a signal generation device 818, such as a speaker or remote control, and a network interface device 820.

In a particular embodiment, as depicted in FIG. 8, the disk drive unit 816 may include a computer-readable medium 822 in which one or more sets of instructions 824, e.g. software, can be embedded. Further, the instructions 824 may embody one or more of the methods or logic as described herein. In a particular embodiment, the instructions 824 may reside completely, or at least partially, within the main memory 804, the static memory 806, and/or within the processor 802 during execution by the computer system 800. The main memory 804 and the processor 802 also may include computer-readable media. The network interface device 820 can provide connectivity to a network 826, e.g., a wide area network (WAN), a local area network (LAN), or other network.

In an alternative embodiment, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 824 or receives and executes instructions 824 responsive to a propagated signal, so that a device connected to a network 826 can communicate voice, video or data over the network 826. Further, the instructions 824 may be transmitted or received over the network 826 via the network interface device 820.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. § 1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A remote control device comprising:
a touch screen configured to display a plurality of buttons for interaction with a television;
a mode module configured to receive a mode request and to populate the touch screen with one of a plurality of button layouts based on the mode request; and
a programming module in communication with the touch screen and with the mode module, the programming module adapted to receive a user defined button layout and to store the user defined button layout in the mode module.

2. The remote control device of claim 1 further comprising:
a connection module in communication with the mode module, the connection module configured to receive a customized button layout from a device and to store the customized button layout in the mode module.

3. The remote control device of claim 1 further comprising:
a detection module in communication with the touch screen, the detection module configured to determine when the remote control device is in communication with a customer premises equipment and configured to populate the touch screen with one of the plurality of button layouts based on the communication with the customer premises equipment.

4. The remote control device of claim 1 wherein the plurality of button layouts corresponds to different devices.

5. The remote control device of claim 1 wherein the plurality of button layouts corresponds to different users.

6. The remote control device of claim 1 wherein the mode request can be selected from a group consisting a television mode, a set-top box mode, a digital video recorder mode, a digital video disc mode, a compact disc mode, a programming mode, and a custom mode.

7. A method comprising:
displaying a plurality of soft buttons on a touch screen for controlling customer premises equipment;
transmitting a control signal to the customer premises equipment corresponding to one of soft buttons;
enabling a first customized a layout of soft buttons;
associating the first customized layout with a user and the customer premises equipment; and
storing the first customized layout as one of a plurality of layouts.

8. The method of claim 7 further comprising:
detecting the customer premises equipment prior to displaying the plurality of soft buttons.

9. The method of claim 7 further comprising:
receiving a second customized button layout from a device; and
storing the second customized button layout as one of the plurality of layouts.

10. The method of claim 7 wherein the touch screen is included on a telephone.

11. The method of claim 7 wherein the customer premises equipment is selected from a group consisting of a set-top box device, a television, a digital video recorder, a video cassette recorder, a digital video disc player, and a compact disc player.

12. A method comprising:
detecting a presence of customer premises equipment;
displaying a first plurality of soft buttons on a touch screen;
receiving a selection of one of the soft buttons;
ending the display of the soft buttons on the touch screen based on the selection of one of the soft buttons; and
displaying a second plurality of soft buttons on the touch screen for controlling the customer premises equipment based on the selection of the one of the first plurality of soft buttons.

13. The method of claim 12 further comprising:
receiving a layout of a third plurality of soft buttons from a device; and
storing the layout of the third plurality of soft buttons.

14. The method of claim 12 wherein each of the first plurality of soft buttons are a different control mode of a remote control.

15. The method of claim 12 wherein each of the second plurality of soft buttons comprises a different control function associated with the customer premises device.

16. A computer readable medium comprising a plurality of instructions to manipulate a processor, the plurality of instructions comprising:
instructions to display a plurality of soft buttons on a touch screen for controlling customer premises equipment;
instructions to transmit a control signal to the customer premises equipment corresponding to one of soft buttons;
instructions to customize a layout of soft buttons;
instructions to associate the customized layout with a user and the customer premises equipment; and
instructions to store the customized layout as one of a plurality of layouts.

17. The computer readable medium of claim 16 further comprising:
instructions to detect the customer premises equipment prior to displaying the plurality of soft button.

18. The computer readable medium of claim 16 further comprising:
instructions to receive a new customized button layout from a device; and
instructions to store the new customized button layout as one of the plurality of layouts.

19. The computer readable medium of claim 16 wherein the touch screen is included on a telephone.

20. The computer readable medium of claim 16 wherein the customer premises equipment is selected from a group consisting of a set-top box device, a television, a digital video recorder, a video cassette recorder, a digital video disc player, and a compact disc player.
